(19) United States
(12) Patent Application Publication
(10) Pub. No.: US 2022/0251791 A1
(43) Pub. Date: Aug. 11, 2022

(54) BOLLARD HAVING AN ACCESS-DENIAL AND A CONNECTED FUNCTION

(71) Applicant: Abdla Feghoul, Cestas (FR)

(72) Inventor: Abdla Feghoul, Cestas (FR)

(21) Appl. No.: 17/295,990

(22) PCT Filed: Nov. 21, 2019
(86) PCT No.: PCT/EP2019/082148

§ 371 Date: May 21, 2021

(30) Foreign Application Priority Data
Nov. 21, 2018 (FR) 1871679

(51) Int. Cl. E01F 13/02; H04W 4/021; H04W 4/80; H04W 84/12

(52) U.S. Cl. CPC E01F 13/026; H04W 84/12; H04W 4/80; H04W 4/021

(57) ABSTRACT

The invention relates to a concrete access-denial bollard (1) for preventing access to vehicles, characterized in that it comprises means for wireless remote communication, in particular for connecting to an Internet network.

The invention relates to the field of concrete bollards used as protection (safety) and anti-intrusion/access-denial devices, in particular intended to be temporarily installed on public roads or in event venues and outdoors in places of pedestrian and vehicle traffic. The invention will be described in more detail, but without being limited thereby, with regard to use for civil defense as protection and access-denial devices to be installed around places in which many people are likely to gather, e.g. during temporary events, to stop any vehicles attempting to charge into the space.

“Temporarily installed” should be understood to mean that the bollards are not permanently fixed to the ground. The bollards of the invention are removable and movable. Despite being removable, the bollards can remain on the ground as long as the user desires.

The applicant has recently developed concrete bollards with an access-denial function, which are described in patent application FR3062142. The dimensions and shape of these concrete bollards make them particularly effective in ensuring the access-denial function. The aim of the invention is to propose an improvement to this type of access-denial bollard.

In the remainder of the description, the terms “horizontal,” “vertical,” “upper,” “lower,” “top,” “bottom,” and “height” will be used in the context of normal installation of a bollard, i.e. relating to the concept of a vertical with respect to a horizontal ground on which the bollard would be placed.

According to the invention, the concrete access-denial bollard (the bollard being capable of being moved in order to be installed on the ground) comprises means for wireless remote communication and thus constitutes a connected object, in particular for connecting to an Internet network in order to connect to at least one server.

In one example of use, a person approaching the connected bollard can, via his smartphone equipped with a dedicated software application, view various information according to the geolocation of the bollard and/or the automatic identification of the bollard. By way of non-limiting examples, the information may relate to events, tourism, transport, or the place (town) where the bollard is located.

In addition, the connected object function can allow advertisements to be downloaded onto smartphone-type screens when a passer-by connects to an application linked to the bollards of the invention, which would help some municipalities to finance the installation of these bollards, the primary function of which is that of access denial for the safety of individuals.

The bollard can be traced remotely. In particular, the bollard comprises a geolocation system.

According to one characteristic, the access-denial bollard comprises at least one casing which is removable with respect to a receiving housing in the bollard or integrated into the bollard during manufacture and constitutes a protective housing for the means of remote communication and any built-in electronics, this volume preferably being inaccessible from outside the bollard when the bollard is in the installed position on the ground.

The bollard preferably comprises electronic data processing means combined with the communication means in order to process the data received from or sent to said communication means, and preferably comprises a geolocation system and/or means for (remotely) identifying said access-denial bollard.

The bollard therefore advantageously comprises means for identifying said access-denial bollard, preferably an electronic tag of the NFC tag type. The logistics of a multitude of bollards are thus facilitated. The identification means preferably comprise an electronic tag of the active and/or passive NFC (near-field communication) tag type, and/or a QR Code and/or an RFID chip. According to another feature, the bollard comprises means for detecting movement of said bollard, the movement detection means being capable of communicating with the wireless remote communication means of said bollard, which are capable of remotely transmitting that the bollard is being displaced/moved. It is thus possible to remotely provide security against the movement or theft of a bollard. In this embodiment, the bollard preferably comprises at least one identifier, and preferably also a geolocation system.

The bollard advantageously comprises electronics-based equipment which provides technical functions such as, but not limited to, a public Wi-Fi broadcasting network, sensors (for example motion detectors, presence detectors, barrier opening when there is a barrier attached to the bollard), cameras (for example to film the external environment or read license plates passing in front of the bollard), alarms (with several levels of visual and audio indication), loudspeakers for broadcasting remote audio messages, electronic displays such as billboards (in particular for advertising with light-emitting diodes) of which the display can be managed remotely, and lighting.

The electronic means of the electronic card type are advantageously accommodated in a housing.

All of the elements of the bollard which require an electrical power supply are powered by a rechargeable battery which is accommodated inside the bollard, preferably in or with the casing.

The access-denial bollard advantageously comprises at least one receiving volume for accommodating said at least one casing, this volume being inaccessible from outside the bollard when the bollard is in the installed position on the ground.

The receiving volume consists, for example, of a blockout which results from the manufacture of the bollard and opens onto the lower face of the bollard, the receiving volume comprising means for fastening and/or retaining the casing in the receiving volume or the casing being integrated into the bollard during manufacture by molding. The receiving volume is preferably closable, e.g. by a closure plate. The closure plate does not protrude from the lower face of the bollard.

The access-denial bollard of the invention preferably does not have definitive means for anchoring it to the ground.

The bollard preferably has a lower end in contact with the ground which does not have recesses with a lifting function, such as recesses for the insertion of forklift claws.

According to a preferred feature, the bollard comprises anchoring means which are configured to interact with special interacting lifting means, the anchoring means only being capable of mutually interacting with a single type of lifting means specifically dedicated to the type of anchoring means, so that the anchoring means cannot interact with a universal lifting/hooking system or a very common lifting system with a very common hook type. Therefore, only specific, uncommon lifting/hooking means can lift the concrete bollard of the invention. Even if the bollards are on public roads, it is impossible to move them without the use of specialized third parties who have lifting cranes equipped with lifting hooks/tools specifically for interaction with the anchoring means of the bollard. By way of example, the anchoring means are in the form of spherical or mushroom anchors of the type marketed by ARTEON.

The access-denial bollard of the invention has other functions in addition to the access-denial function. The bollard may comprise specific blockouts and/or fastening means which allow technical equipment such as that described non-exhaustively in patent application FR3062142 to be attached and mounted on the bollard directly on-site. Advantageously, said at least one concrete access-denial bollard is such that the entire bollard is based on concrete, preferably fiber-reinforced concrete, or the bollard has at least one concrete-based envelope, or the bollard has a metal shell and a concrete inner body.

According to another feature, the body of the bollard has edges which are beveled, the body in particular having a parallelepipedal general shape and at least the edges thereof referred to as vertical when the bollard is in the installed position, the edges of the upper face, and optionally the edges of any surface indentation being beveled.

According to another feature, the body of the concrete bollard comprises at least two opposite faces, referred to as lower and upper, and a peripheral wall referred to as the side wall connecting the two opposite faces, the outer surface of the side wall comprising, preferably over its entire periphery and preferably in its middle part, a groove (with solid bottom and walls) forming an indentation in the external surface (toward the inside of the body). The groove (preferably arranged in a horizontal median plane of the bollard) extends upward, and in particular has a width corresponding to approximately one third of the height of the bollard.

Technical equipment can be attached to the groove, such as a camera which will thus be at the level of the license plates of vehicles passing near the bollard.

The concrete bollard advantageously comprises at least one lighting system and/or means for location at night, in particular a reflector, in particular positioned in the lower part of the bollard when the bollard is in the installed position and capable of illuminating upward, and preferably capable of illuminating with an illumination angle which corresponds to the two upper (i.e. of the upper end) angles (i.e. corners) of the bollard for identifying the volume of the bollard at night.

The invention also relates to a device for managing at least one access-denial bollard of the invention, and optionally its technical equipment, the device comprising at least one server (physical or virtual) for centralizing data capable of communicating with the bollard provided with remote communication means and electronic data processing means, and at least one software application that communicates with the server, preferably at least one master software application which makes it possible to identify and locate said access-denial bollard of the invention and at least one client software application which allows communication with the bollard (via Bluetooth and/or Wi-Fi to provide various information to the user of the application, for example related to the town where the bollards are placed or to an event).

The invention thus relates to a novel use of remote communication means, this use being characterized in that the remote communication means are integrated into a concrete access-denial and anti-intrusion bollard for vehicles, in particular outdoors in places of pedestrian and vehicle traffic.

The present invention will now be described with the aid of examples which are only illustrative and do not limit the scope of the invention in any way, and with reference to the accompanying drawings, in which:

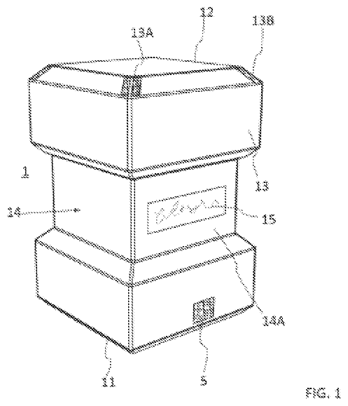

FIG. 1 is a perspective view of an access-denial bollard according to the invention.

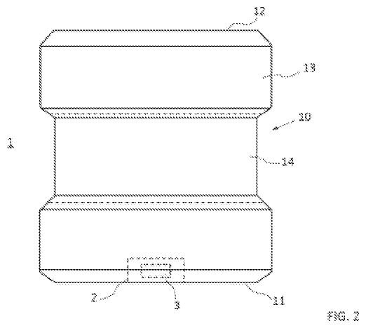

FIG. 2 is a side view of the bollard from FIG. 1 which shows the interior of the bollard for accommodating a connected casing in dotted lines.

The access-denial bollard 1 of the invention shown in the drawings, in combination with its access-denial function, constitutes a connected object.

The concrete bollard 1 of the invention shown in the drawings is a solid concrete bollard of substantial mass, in particular of approximately 500 kg up to more than one ton, intended primarily as an access-denial bollard for vehicles.

The concrete bollard is preferably made of fiber-reinforced concrete. It may optionally have an outer shell, such as a metallic shell, into which the concrete is poured.

The appearance of the bollard 1 is of the type described in patent application FR3062142 or WO2018138276 which is incorporated by reference into the present patent application.

With reference to FIGS. 1 and 2, the concrete bollard 1 comprises a cylindrical body 10, comprising a lower face 11, an opposite upper face 12, and a vertical peripheral side wall 13 connecting the two faces 11 and 12. The base of the cylindrical body is preferably polygonal, but could be round, oval, etc. According to a preferred example, the body is parallelepipedal with a square or rectangular base, the peripheral wall 13 comprising four vertical faces.

The body 10 of the bollard preferably comprises, on its side wall 13, surrounding said wall and in the middle part thereof, a blockout 14 forming a peripheral groove. This peripheral groove 14 comprises a bottom 14A which is therefore located in a plane that is parallel and offset with respect to the external plane of the side wall 13.

The blockout 14 can be used, for example, as a support for a sign, such as a plate 15, the plate being suitable in particular for being covered with a film with micro prisms and with very high retroreflectivity. The blockout 14 is advantageously at, or substantially at, the corresponding height of a car license plate. The bollards 1 of the invention are therefore easily identifiable at night by the lighting of passing motor vehicles.

The lower face 11 is advantageously completely flat, so that it is impossible to lift the bollard from its base when the bollard is in the installed position on the ground.

As can be seen in the embodiment shown, the bollard is parallelepipedal with a square base and symmetrical with respect to the median horizontal plane.

The edges of the body 10 which delimit the lower face 10 and upper face 11, the vertical faces of the side wall 13, and the groove 14 are preferably beveled (have inclined sides) and/or rounded so as to avoid sharp edges which could otherwise cause injury, especially since the bollard may be almost as tall as a person.

The concrete bollard 1 preferably comprises, with respect to FIG. 2, a lighting system S, in particular a reflector, which is in particular positioned in the lower part of the bollard and is capable of illuminating upward so as to illuminate with an illumination angle corresponding to two upper corners 13A and 13B of the bollard for identifying the volume of the bollard at night.

The dimensions of the bollard 1 are preferably designed to be suitable for maximizing the number thereof in a 10-ton transport truck.

By way of non-limiting example, the dimensions of a parallelepipedal bollard 1 of the invention with a square or rectangular base are as follows:
Height: 900 or 950 mm
Width and length: 900 or 950 mm×900 mm or 950 mm for a square base, and 600 mm×900 mm for a rectangular base,
Height of groove 13: 200 or 210 mm,
Depth of the groove (dimension in a horizontal plane): approximately 50 mm.

According to the invention, the bollard 1 comprises at least one blockout or a receiving volume in the lower part which opens onto the lower face of the bollard so as to be inaccessible when the bollard is in the installed position on the road. This receiving volume is preferably closable.

According to the invention, the bollard 1 comprises at least one casing 3 accommodating the remote communication means, in particular for connecting to the Internet, such that it constitutes a connected object. The casing is suitable for being accommodated in the receiving volume 2.

The bollard 1 preferably further comprises geolocation means.

The bollard 1 preferably also includes means for identifying the bollard, preferably remotely, so as to be able to trace the bollard. The bollard 1 comprises an NFC tag, for example.

The bollard can be equipped with elements with a technical function which are capable of communicating with the remote communication means in order to transmit or receive data which are associated with said technical elements.

The elements with a technical function are, but are not limited to, sensors, cameras, display systems, loudspeakers intended to be connected to the remote communication means of the bollard.

For example, the bollard is equipped with at least one camera (for example via a pole fastened to the bollard) which is capable of communicating in a wired or wireless manner with electronic processing means accommodated inside the bollard, preferably in the casing accommodating the remote communication means. The data (images) of the environment of the bollard can thus be sent to a server via the means of remote communication.

The access-denial bollard 1 comprises, for example, as a sensor, a movement sensor, making it possible to detect the movement of the bollard. Since the sensor is connected to the means of remote communication, it is thus possible to detect remotely that the bollard has been moved.

The access-denial bollard 1 is capable of communicating with a remote server (physical or virtual) for centralizing data. Software applications relating to the bollard or bollards are also provided. A master software application makes it possible to identify and locate the access-denial bollards. A client software application allows communication with the bollard and also allows, via the detection of the bollard, various information on a place, an event, etc. to be viewed, for example on a smartphone or tablet.

1. Concrete access-denial bollard (1) for vehicles, characterized in that it comprises means of wireless remote communication, in particular for connecting to an Internet network.

2. The access-denial bollard according to claim 1, characterized in that it comprises electronic data processing means combined with the communication means in order to process the data received from or sent to said communication means.

3. The access-denial bollard according to claim 1, characterized in that it comprises a geolocation system.

4. The access-denial bollard according to claim 1, characterized in that it comprises means for identifying said access-denial bollard, preferably an electronic tag of the NFC tag type.

5. The access-denial bollard according to claim 1, characterized in that it comprises means for detecting movement of said bollard, and in that the movement detection means are capable of communicating with the wireless remote communication means of said bollard, which are capable of remotely transmitting that the bollard is being moved.

6. The access-denial bollard according to claim 1, characterized in that it comprises at least one casing which is removable with respect to a receiving housing in the bollard or integrated into the bollard during manufacture and constitutes a protective housing for the means of remote communication and any built-in electronics, this volume preferably being inaccessible from outside the bollard when the bollard is in the installed position on the ground.

7. The access-denial according claim 6, characterized in that the receiving volume, which is preferably sealable, consists of a blockout which results from the manufacture of the bollard and opens onto the lower face of the bollard intended to be in contact with the ground, the receiving volume comprising means for fastening and/or retaining the casing in the receiving volume, or the casing being integrated into the bollard during manufacture by molding.

8. The access-denial bollard according to claim 1, characterized in that all of the elements of the bollard which require an electrical power supply are powered by a battery which is accommodated inside the bollard, preferably in or with the casing.

9. The access-denial bollard according to claim 1, characterized in that said at least one concrete access-denial bollard (1) is such that the entire bollard is based on concrete, preferably fiber-reinforced concrete, or the bollard has at least one concrete-based envelope, or the bollard has a metal shell and a concrete inner body.

10. The access-denial bollard according to claim 1, characterized in that it comprises electronics-based equipment which provides technical functions, the equipment being equipment such as a public Wi-Fi broadcasting network, sensors, cameras, alarms, loudspeakers for broadcasting remote audio messages, electronic displays, and lighting.

11. The access-denial bollard according to claim 1, characterized in that the body of the concrete bollard comprises at least two opposite faces, referred to as lower and upper, and a peripheral wall referred to as the side wall connecting the two opposite faces, the outer surface of the side wall comprising, preferably over its entire periphery and preferably in its middle part, a groove forming an indentation in the external surface.

12. The access-denial bollard according to claim 1, characterized in that the body of said at least one access-denial bollard (1) has edges which are beveled, the body in particular having a parallelepipedal general shape and at least the edges thereof referred to as vertical when the bollard is in the installed position, the edges of the upper face, and optionally the edges of any surface indentation being beveled.

13. The device for managing at least one access-denial bollard according to claim 1, and optionally its technical equipment, the management device comprising at least one server for centralizing data capable of communicating with the bollard provided with remote communication means and electronic data processing means, and at least one software application that communicates with the server, preferably at least one master software application which makes it possible to identify and locate said access-denial bollard of the invention and at least one client software application which allows communication with the bollard.
